(19) United States
(12) Patent Application Publication
(10) Pub. No.: US 2006/0000308 A1
(43) Pub. Date: Jan. 5, 2006

(54) Axle assembly with opposed electric motor carrier

(76) Inventors: John L. Bennett, Fraser, MI (US); Richard Gady, Rochester Hills, MI (US); Thomas E. Baker, Royal Oak, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/881,361

(22) Filed: Jun. 30, 2004

(51) Int. Cl. B60K 1/00

(52) U.S. Cl. 74/661

(57) ABSTRACT

An axle assembly includes a first and a second electric motor which drive a gearbox assembly substantially therebetween. A proper gear teeth contact pattern between the electric motor drive gears and a ring gear is obtained by adjusting electric motor housing portions relative a main housing portion.

### BACKGROUND OF THE INVENTION

The present invention relates to an axle assembly that utilizes a plurality of electric motors, and more particularly to an axle configuration which locates the electric motors in an opposed arrangement to the axle.

There is an increasing demand for the use of hybrid electric driven and hybrid electric assisted vehicles. Hybrid electric vehicles typically utilize electric motor driven axles, which are often of a multi-axle configuration in military and specialty vehicles systems.

The electric motors are typically sized to meet both torque and speed requirements, which may not be the most effective for the operational requirements of such vehicles. Relatively large electric motors are often utilized to meet the torque requirements, which may result in an oversized motor for most operational conditions. Moreover, the relatively large electric motors may be difficult to package in a multi-axle vehicle configuration. Conversely, utilizing a multiple of relatively smaller electric motors may increase complexity and the difficulty of obtaining a proper gear teeth contact pattern.

Accordingly, it is desirable to provide a lightweight and compact electric motor driven axle configuration which allows the usage of a multiple of relatively smaller electric motors without greatly complicating obtainment of a proper gear teeth contact pattern.

### SUMMARY OF THE INVENTION

The axle assembly according to the present invention includes a first and a second electric motor which drives a gearbox assembly substantially therebetween. The electric motors drive the gearbox assembly, which drives the vehicle wheels through a first and second axle shaft located along a first axis.

The electric motors each include an output shaft which mount a drive gear respectively thereto. Each drive gear is engaged with and drives a single hollow ring gear which drives the axle shafts. The hollow ring gear is positionally fixed within a main housing portion of a housing assembly. Electric motor housing portions are mounted to the main housing portion and each electric motor is mounted to a respective electric motor housing portion.

A proper gear teeth contact pattern between the drive gear and the ring gear is obtained by adjusting the electric motor housing portion relative the main housing portion. A shim plate is located between the electric motor housing portion and the main housing portion to axially adjust the drive gear relative the ring gear. To radially adjust the drive gear relative the ring gear, elongated apertures are located through the electric motor housing portion to permit the electric motor housing portion to be shifted relative the main housing portion.

The present invention therefore provides a lightweight and compact electric motor driven axle configuration, which allows the usage of a multiple of relatively smaller electric motors without greatly complicating obtainment of a proper gear teeth contact pattern.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of an exemplary multi-axle vehicle embodiment for use with the present invention;

FIG. 2 is a schematic view of an axle assembly of the present invention;

FIG. 3 is a sectional top view of an axle assembly of the present invention; and

FIG. 4 is a side view of an electric motor housing portion of the present invention.

### DETAILED DESCRIPTION OF THE PREFERRED EMBODIMENT

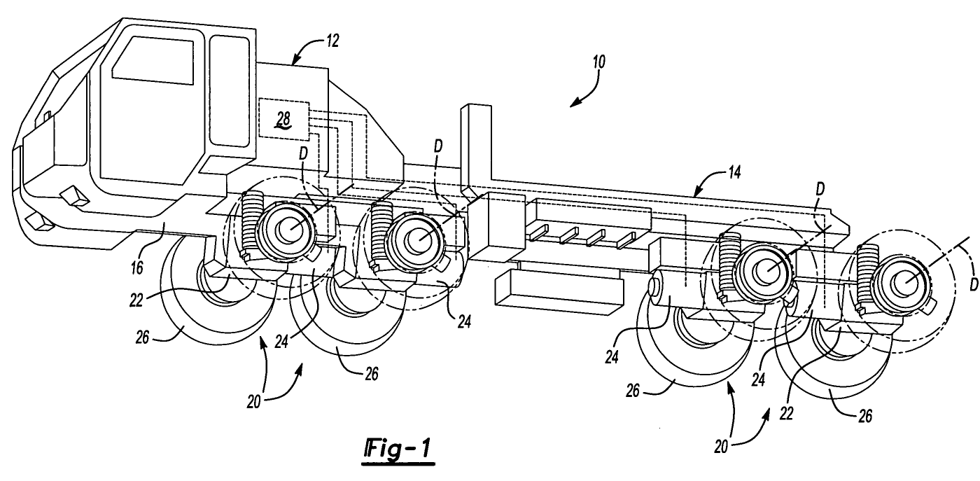

FIG. 1 illustrates a schematic partial phantom view of a multi-axle vehicle 10 having a body 12 supported upon a frame 14. The frame 14 preferably includes a pair of main longitudinal members 16. It should be understood that although a particular vehicle arrangement is disclosed in the illustrated embodiment, other vehicles will benefit from the present invention.

A multiple of axle assemblies 20 each includes an axle 22 driven by one or more electric motors 24. Each axle assembly 20 defines an axis of rotation D substantially transverse the longitudinal members 16 to drive one or more wheels 26. The electric motors 24 are driven by a prime mover 28, which is preferably a hybrid electric drive that powers each of the axle assemblies 20 by powering the electric motors 24. It should be understood, however, that other prime movers such as diesel engines, gas turbines among others will also benefit from the present invention.

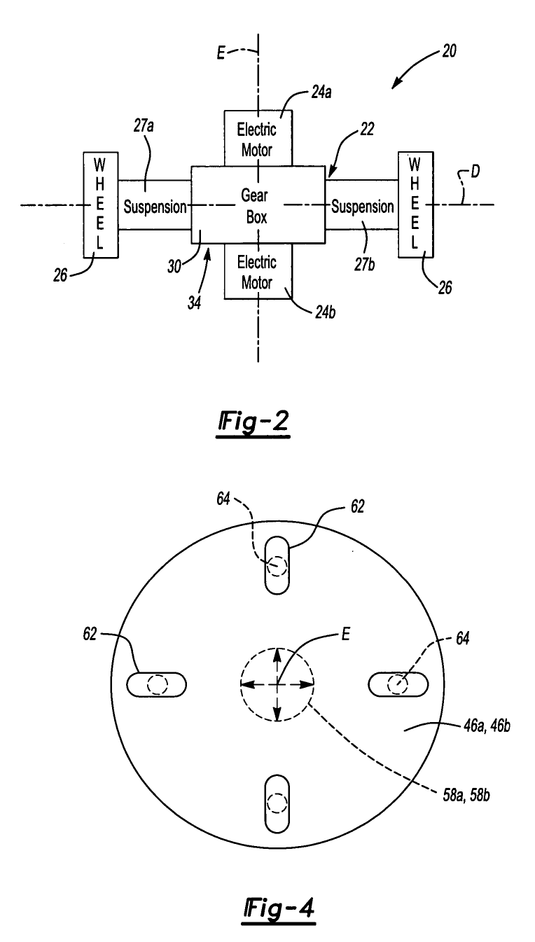

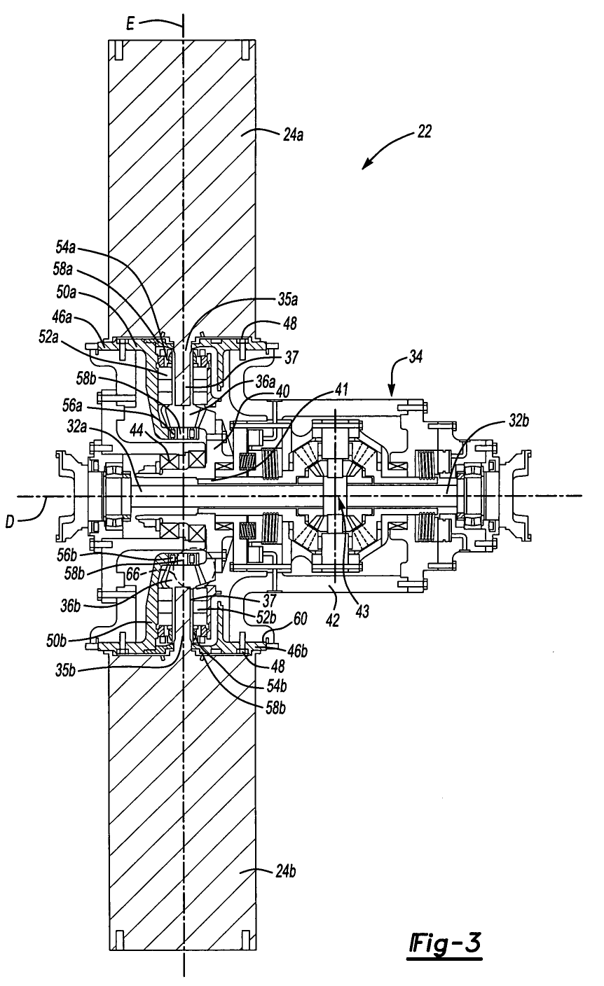

Referring to FIG. 2, a first and a second electric motor 24a, 24b drive a gearbox assembly 30, which drives the wheels 26 through a first axle shaft 32a and a second axle shaft 32b (FIG. 3) located along axis D and contained with a housing assembly 34. The axle shafts 32a, 32b preferably drive each set of one or more wheels 26 through an independent suspension system 27a, 27b (illustrated schematically) however, a rigid axle arrangement will also benefit from the present invention.

The electric motors 24a, 24b are located along axis E, which is substantially perpendicular to axis D. The axle assembly 20 may alternatively be powered by a single electric motor to provide a relatively lighter duty axle assembly for yet another vehicle configuration without major modification to the axle assembly. It should be understood that various combinations of the axle assemblies described herein may be provided to particularly tailor an axle assembly to a particular vehicle in a modular manner.

Referring to FIG. 3, the electric motors 24a, 24b each include an output shaft 35a, 35b which mount a drive gear 36a, 36b respectively thereto. The drive gears 36a, 36b are preferably hollow pinion gears which are mounted at least partially over the output shafts 35a, 35b and are rotationally engaged therewith through splines 37 or the like. That is, the drive gears 36a, 36b at least partially telescope over the output shafts 35a, 35b

Each drive gear 36a, 36b is engaged with and drives a single hollow ring gear 40 which drives the first axle shaft 32a. That is, the ring gear is coaxial with axis D and the hollow ring gear 40 is rotationally engaged with the first axle shaft 32a through splines 41 or the like. The first axle shaft 32a drives the second axle shaft 32b through a gearbox 43 such as a differential or the like. The gearbox 43 may additionally include a speed reduction gearbox to provide a relatively lightweight and compact axle assembly, which will benefit from an electric motor of reduced size.

The hollow ring gear 40 is positionally fixed within a main housing portion 42 of the housing assembly 34 and mounted within a bearing 44 for rotation about axis D. That is, the hollow ring gear 40 is generally not adjustable and gear teeth contact pattern adjustment is through adjustment of the drive gear 36a, 36b relative the ring gear 40.

The housing assembly 34 includes an electric motor housing portion 46a, 46b which is mounted to the main housing portion 42 through fasteners 48 such as bolts or the like. Each electric motor 24a, 24b is mounted to a respective electric motor housing portion 46a, 46b. Each electric motor housing portion 46a, 46b includes a generally cylindrical pinion housing portion 50a, 50b which rotationally supports and at least partially surrounds the drive gears 36a, 36b, respectively. Bearings 52a, 52b are mounted within the pinion housing portion 50a, 50b to support the drive gears 36a, 36b. A retainer assembly 54a, 54b such as a nut and washer is threaded onto an end of each drive gear 36a, 36b to provide axial retention of the bearings 52a, 52b and drive gear 36a, 36b along axis E.

Preferably, each pinion housing portion 50a, 50b mounts an end bearing 56a, 56b which retains a pinion shaft portion 58a, 58b which extends from the end of the drive gears 36a, 36b. In other words, each drive gear 36a, 36b is axial trapped but supported for rotation within the cylindrical pinion housing portion 50a, 50b between the retainer assembly 54a, 54b, the bearings 52a, 52b, and the end bearings 56a, 56b. An electric motor housing access plate 58a, 58b is preferably located within the electric motor housing portion 46a, 46b to provide access, assembly, and maintenance to the retainer assembly 54a, 54b and the bearings 52a, 52b.

The gear teeth contact pattern between the drive gear 36a, 36b and the ring gear 40 is obtained by adjusting the electric motor housing portion 46a, 46b relative the main housing portion 42. Preferably, a shim plate 60 is located between the electric motor housing portion 46a, 46b and the main housing portion 42 to axially adjust the drive gear 36a, 36b relative the ring gear 40 along axis E. To radially adjust the drive gear 36a, 36b relative the ring gear 40, elongated apertures 62 are located through the electric motor housing portion 46a, 46b (FIG. 4) to receive the fasteners 48. That is, the fasteners 48 are threaded into a threaded apertures 64 which are located in the main housing portion 42 while the elongated apertures 62 permit the electric motor housing portion 46a, 46b to be shifted relative the main housing portion 42. Shifting of the electric motor housing portion 46a, 46b and the main housing portion 42 is accommodated by the elongated apertures 62 such that the proper gear teeth contact pattern is achieved. It should be understood that although both electric motor 24a, 24b are illustrated as mounted along common axis E, each electric motor 24a, 24b is independently positionable. Achievement of the proper gear teeth contact pattern during assembly of each the drive gear 36a, 36b may result in the electric motor 24a, 24b not being arranged along a common axis in practice.

Preferably, an access cover (illustrated in phantom at 66) is located through the main housing portion 42 to permit inspection and adjustment of the gear teeth contact pattern during assembly of the electric motor housing portion 46a, 46b and the main housing portion 42.

It should be further understood that various bearing and seal locations are included within the gearbox. One of ordinary skill in the art, with the benefit of this disclosure, will consider the various bearing and seal locations to be an ordinary engineering problem such that intricate details thereof need not be fully discussed herein.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An axle assembly comprising:
a first housing portion;
a ring gear rotationally mounted within said first housing portion for rotation about a first axis;
a second housing portion mountable to said first housing portion;
a drive gear rotationally mounted to said second housing portion, said drive gear mounted for rotation about a second axis transverse said first axis such that a gear teeth contact pattern between said ring gear and said drive gear is adjusted in response to a relative position between said first housing portion and said second housing portion.

2. The axle assembly as recited in claim 1, further comprising an electric motor which drives said drive gear.

3. The axle assembly as recited in claim 2, wherein said electric motor is mountable to said second housing portion.

4. The axle assembly as recited in claim 1, wherein said drive gear comprises a hollow pinion mountable over an output shaft of an electric motor.

5. The axle assembly as recited in claim 4, wherein said hollow pinion is rotationally mounted at least partially within a generally cylindrical pinion housing portion which extends from said second housing portion.

6. The axle assembly as recited in claim 4, wherein said hollow pinion comprises a pinion shaft portion which extends from an end of said hollow pinion, said pinion shaft portion received within an end bearing retained within a generally cylindrical pinion housing portion which extends from said second housing portion.

7. The axle assembly as recited in claim 1, further comprising a bearing which rotationally mounts said drive gear within a generally cylindrical pinion housing portion which extends from said second housing portion.

8. The axle assembly as recited in claim 1, further comprising a shim plate between said first housing portion and said second housing portion.

9. The axle assembly as recited in claim 1, wherein said second housing portion comprises a multiple of elongated fastener apertures.

10. The axle assembly as recited in claim 9, wherein said first housing portion comprises a multiple of threaded fastener apertures.

11. The axle assembly as recited in claim 1, wherein said ring gear is coaxial with a drive shaft about said first axis.

12. The axle assembly as recited in claim 1, wherein said ring gear is splined to a drive shaft about said first axis, said drive shaft passing through said ring gear.

13. The axle assembly as recited in claim 1, further comprising a third housing portion mountable to said first housing portion opposed to said second housing portion.

14. The axle assembly as recited in claim 1, further comprising a second electric motor mountable to said third housing portion generally parallel to said second axis.

15. A method of mounting a multiple of electric motors to an axle assembly comprising the steps of:
(1) mounting a ring gear within a first housing portion for rotation about a first axis;
(2) mounting a first drive gear to a second housing portion;
(3) mounting a second drive gear to a third housing portion; and
(4) adjusting a gear teeth contact pattern between the ring gear and the first and second drive gear in response to a relative position between the second housing portion and the first housing portion and the third housing portion and the first housing portion.

16. A method as recited in claim 15, further comprising the steps of:
(a) mounting a first electric motor to the second housing portion; and
(b) mounting a second electric motor to the third housing portion.

17. A method as recited in claim 16, further comprising the steps of:
(a) telescoping an output shaft of the first electric motor into the first drive gear; and
(b) telescoping an output shaft of the first electric motor into the first drive gear.
